(19) United States
(12) Patent Application Publication
(10) Pub. No.: US 2006/0088681 A1
(43) Pub. Date: Apr. 27, 2006

(54) Method of new type of removable self-stick notes with adjustable dimensions available for users

(76) Inventor: Desheng Chen, Dalian Liaoning (CN)

Correspondence Address: Desheng Chen, Xinsheng 27 3 308 Zhongshan, District Dalian, Dalian, 116001, CN

(21) Appl. No.: 10/495,140

(22) PCT Filed: Jun. 12, 2003
(86) PCT No.: PCT/IB03/02577

§ 371 Date: May 10, 2004

(30) Foreign Application Priority Data
Jul. 2, 2002 (CN) 021250642

(51) Int. Cl. B32B 33/00

(52) U.S. Cl. 428/40.1

(57) ABSTRACT

This invention offers users innovative removable self-stick notes, series of pinholes (perforations) are to be punched on removable self-stick notes, it's function just resembling those teeth found on postage stamps; these pinholes therefore split a large notes into various smaller-sized notes whose dimensions vary; Users thus could pick and remove one smaller-sized note(notes) of desirable size off that big holding note, considering the amount of words he/she is planning to create; This effectively resolved the defect inherent in currently available type of notes: dimensions of these notes are determined and fixed by manufacturers; thus then practically reduced users' costs, and further helped preserve social resources.

### CROSS-REFERENCE

This application is a continuation of International Application PCT/IB03/02577, with an international filing date of Jun. 12, 2003, which claims benefit of Invention Application Serial No. 02125064.2 filed Jul. 02, 2002. (CHINA, now pending)

### FIELD OF THE INVENTION

This invention relates to removable self-stick notes, especially it is a new type of removable self-stick notes with adjustable dimensions available for users.

### BACKGROUND OF THE INVENTION

Removable self-stick notes is then an innovative office supply: it functions as a reminder of matters require timely follow-up and prompts the doer to execute, posted to any conspicuous position and readily communicating information in a timely manner. It is intensively utilized in works, partly due to its qualities of convenience and usability.

Nevertheless, during the practical application process of these varieties of self-stick notes available on current market, an inherent defect was found therein: since dimensions of these notes are determined and fixed by manufacturers.

While, for users: sometimes there are quite considerable amount of words required to be taken; sometimes just few words is enough; therefore, when small size of notes are purchased, they can not meet users' demands where there are quite many words required; when larger size of notes are purchased, they are most likely to enable the remaining large area of blank note to be meaninglessly wasted, where there is just few sentences to be taken.

### SUMMARY OF THE INVENTION

Targeted to solve defects in current removable self-stick notes, the present invention relates to provide reformative notes which is capable of reducing unnecessary waste: This new type removable self-stick notes is capable of independent adjust dimensions by users—a bigger note could be therefore divided into certain numbers of smaller-sized notes.

Series of pinholes(perforations) or traces are to be punched on removable self-stick notes; these pinholes or traces therefore split a large note into various smaller-sized notes. And, pinholes or traces of varieties of color is available and applicable, this makes smaller-sized notes so created more conspicuous.

Users thus could pick and remove one smaller-sized notes(notes) of desirable size off that big holding note, considering the amount of words he/she is planning to create; this selection is achievable as easily as picking one stamp among a group of interconnected stamps by means of pinholes or traces.

### DETAILED DESCRIPTION OF THE INVENTION

A description of preferred embodiments of the invention follows: series of pinholes are to be punched on removable self-stick notes, it's function just resembling those teeth found on postage stamps; these pinholes therefore split a large notes into various smaller-sized notes.

Users thus could pick and remove one smaller-sized note(notes) of desirable size off that big holding note, considering the amount of words he/she is planning to create.

What I (We) claim as my invention is:

1. new type of removable self-stick notes with adjustable dimensions available for users:
series of pinholes(perforations) or traces are to be punched on removable self-stick notes, it's function just resembling those teeth found on postage stamps; and
these pinholes therefore split a large notes into various smaller-sized notes;
Users thus could pick and remove one smaller-sized note(notes) of desirable size off that big holding note, considering the amount of words he/she is planning to create.

2. According to claim 1: pinholes or traces of varieties of color is available and applicable, this makes smaller-sized notes so created more conspicuous.
